(19) United States
(12) Patent Application Publication
(10) Pub. No.: US 2003/0191641 A1
(43) Pub. Date: Oct. 9, 2003

(54) Method of iterative noise estimation in a recursive framework

(76) Inventors: Alejandro Acero, Bellevue, WA (US); Li Deng, Redmond, WA (US); James G. Droppo, Duvall, WA (US)

Correspondence Address: Steven M. Koehler, WESTMAN CHAMPLIN & KELLY, Suite 1600 - International Centre, 900 South Second Avenue, Minneapolis, MN, 55402-3319, US

(21) Appl. No.: 10/237,162

(22) Filed: Sep. 6, 2002

Related U.S. Application Data
(63) Continuation-in-part of application No. 10/116,792, filed on Apr. 5, 2002.

(51) Int. Cl. G10L 15/20

(52) U.S. Cl. 704/233

(57) ABSTRACT

A method and apparatus estimate additive noise in a noisy signal using an iterative technique within a recursive framework. In particular, the noisy signal is divided into frames and the noise in each frame is determined based on the noise in another frame and the noise determined in a previous iteration for the current frame. In one particular embodiment, the noise found in a previous iteration for a frame is used to define an expansion point for a Taylor series approximation that is used to estimate the noise in the current frame. In one embodiment, noise estimation employs a recursive-Expectation-Maximization framework with a maximum likelihood (ML) criteria. In a further embodiment, noise estimation employs a recursive-Expectation-Maximization framework based on a MAP (maximum a posterior) criteria.

### CROSS REFERENCE TO RELATED APPLICATIONS

This application is a continuation-in-part of application Ser. No. 10/116,792, filed Apr. 5, 2002, the priority of which is hereby claimed.

### BACKGROUND OF THE INVENTION

The present invention relates to noise estimation. In particular, the present invention relates to estimating noise in signals used in pattern recognition.

A pattern recognition system, such as a speech recognition system, takes an input signal and attempts to decode the signal to find a pattern represented by the signal. For example, in a speech recognition system, a speech signal (often referred to as a test signal) is received by the recognition system and is decoded to identify a string of words represented by the speech signal.

Input signals are typically corrupted by some form of noise. To improve the performance of the pattern recognition system, it is often desirable to estimate the noise in the noisy signal.

In the past, two general frameworks have been used to estimate the noise in a signal. In one framework, batch algorithms are used that estimate the noise in each frame of the input signal independent of the noise found in other frames in the signal. The individual noise estimates are then averaged together to form a consensus noise value for all of the frames. In the second framework, a recursive algorithm is used that estimates the noise in the current frame based on noise estimates for one or more previous or successive frames. Such recursive techniques allow for the noise to change slowly over time.

In one recursive technique, a noisy signal is assumed to be a non-linear function of a clean signal and a noise signal. To aid in computation, this non-linear function is often approximated by a truncated Taylor series expansion, which is calculated about some expansion point. In general, the Taylor series expansion provides its best estimates of the function at the expansion point. Thus, the Taylor series approximation is only as good as the selection of the expansion point. Under the prior art, however, the expansion point for the Taylor series was not optimized for each frame. As a result, the noise estimate produced by the recursive algorithms has been less than ideal.

In light of this, a noise estimation technique is needed that is more effective at estimating noise in pattern signals.

### SUMMARY OF THE INVENTION

A method and apparatus estimate additive noise in a noisy signal using an iterative technique within a recursive framework. In particular, the noisy signal is divided into frames and the noise in each frame is determined based on the noise in another frame and the noise determined in a previous iteration for the current frame. In one particular embodiment, the noise found in a previous iteration for a frame is used to define an expansion point for a Taylor series approximation that is used to estimate the noise in the current frame.

In one embodiment, noise estimation employs a recursive-Expectation-Maximization framework with a maximum likelihood (ML) criteria. In a further embodiment, noise estimation employs a recursive-Expectation-Maximization framework based on a MAP (maximum a posterior) criteria. The noise estimate utilizing MAP criteria uses and improves upon the ML criteria by including prior information based on portions of a pattern signal that contains only noise, for example, portions preceding and/or following a portion with observation data. The prior information constrains the maximum likelihood auxiliary function by providing, in effect, a range in which the noise should fall within.

### BRIEF DESCRIPTION OF THE DRAWINGS

FIG. 1 is a block diagram of one computing environment in which the present invention may be practiced.

FIG. 2 is a block diagram of an alternative computing environment in which the present invention may be practiced.

FIG. 3 is a flow diagram of a method of estimating noise under one embodiment of the present invention.

FIG. 4 is a pictorial representation of an utterance.

FIG. 5 is a flow diagram of a method of estimating noise under another embodiment of the present invention.

FIG. 6 is a block diagram of a pattern recognition system in which the present invention may be used.

### DETAILED DESCRIPTION OF ILLUSTRATIVE EMBODIMENTS

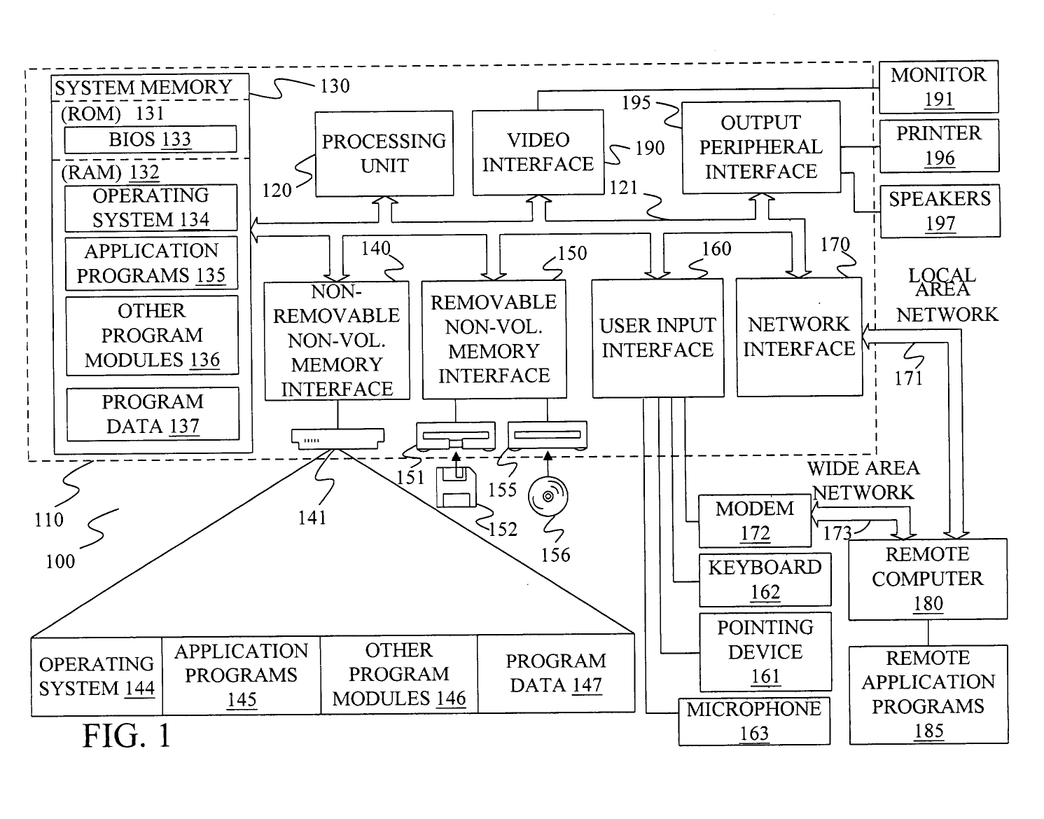

FIG. 1 illustrates an example of a suitable computing system environment 100 on which the invention may be implemented. The computing system environment 100 is only one, example of a suitable computing environment and is not intended to suggest any limitation as to the scope of use or functionality of the invention. Neither should the computing environment 100 be interpreted as having any dependency or requirement relating to any one or combination of components illustrated in the exemplary operating environment 100.

The invention is operational with numerous other general purpose or special purpose computing system environments or configurations. Examples of well-known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, telephony systems, distributed computing environments that include any of the above systems or devices, and the like.

The invention may be described in the general context of computer-executable instructions, such as program modules, being executed by a computer. Generally, program modules include routines, programs, objects, components, data structures, etc. that perform particular tasks or implement particular abstract data types. Tasks performed by the programs and modules are described below and with the aid of figures. Those skilled in the art can implement the description and figures as computer-executable instructions, which can be embodied on any form of computer readable media discussed below.

The invention may also be practiced in distributed computing environments where tasks are performed by remote processing devices that are linked through a communications network. In a distributed computing environment, program modules may be located in both local and remote computer storage media including memory storage devices.

With reference to FIG. 1, an exemplary system for implementing the invention includes a general-purpose computing device in the form of a computer 110. Components of computer 110 may include, but are not limited to, a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can be accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 1 illustrates operating system 134, application programs 135, other program modules 136, and program data 137.

The computer 110 may also include other removable/non-removable volatile/nonvolatile computer storage media. By way of example only, FIG. 1 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 1, provide storage of computer readable instructions, data structures, program modules and other data for the computer 110. In FIG. 1, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies.

A user may enter commands and information into the computer 110 through input devices such as a keyboard 162, a microphone 163, and a pointing device 161, such as a mouse, trackball or touch pad. Other input devices (not shown) may include a joystick, game pad, satellite dish, scanner, or the like. These and other input devices are often connected to the processing unit 120 through a user input interface 160 that is coupled to the system bus, but may be connected by other interface and bus structures, such as a parallel port, game port or a universal serial bus (USB). A monitor 191 or other type of display device is also connected to the system bus 121 via an interface, such as a video interface 190. In addition to the monitor, computers may also include other peripheral output devices such as speakers 197 and printer 196, which may be connected through an output peripheral interface 190.

The computer 110 may operate in a networked environment using logical connections to one or more remote computers, such as a remote computer 180. The remote computer 180 may be a personal computer, a hand-held device, a server, a router, a network PC, a peer device or other common network node, and typically includes many or all of the elements described above relative to the computer 110. The logical connections depicted in FIG. 1 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the user input interface 160, or other appropriate mechanism. In a networked environment, program modules depicted relative to the computer 110, or portions thereof, may be stored in the remote memory storage device. By way of example, and not limitation, FIG. 1 illustrates remote application programs 185 as residing on remote computer 180. It will be appreciated that the network connections shown are exemplary and other means of establishing a communications link between the computers may be used.

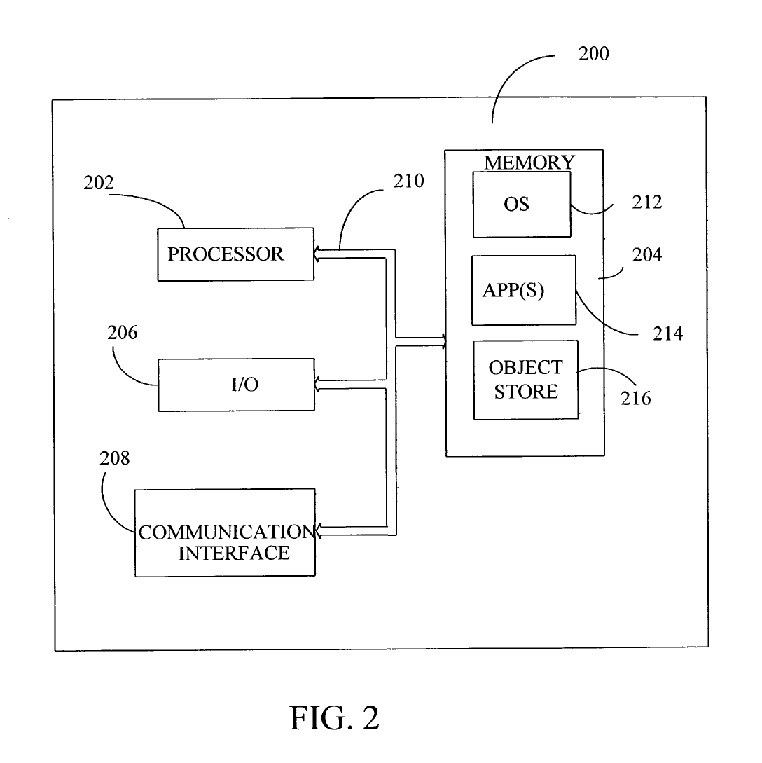

FIG. 2 is a block diagram of a mobile device 200, which is an exemplary computing environment. Mobile device 200 includes a microprocessor 202, memory 204, input/output (I/O) components 206, and a communication interface 208 for communicating with remote computers or other mobile devices. In one embodiment, the afore-mentioned components are coupled for communication with one another over a suitable bus 210.

Memory 204 is implemented as non-volatile electronic memory such as random access memory (RAM) with a battery back-up module (not shown) such that information stored in memory 204 is not lost when the general power to mobile device 200 is shut down. A portion of memory 204 is preferably allocated as addressable memory for program execution, while another portion of memory 204 is preferably used for storage, such as to simulate storage on a disk drive.

Memory 204 includes an operating system 212, application programs 214 as well as an object store 216. During operation, operating system 212 is preferably executed by processor 202 from memory 204. Operating system 212, in one preferred embodiment, is a WINDOWS® CE brand operating system commercially available from Microsoft Corporation. Operating system 212 is preferably designed for mobile devices, and implements database features that can be utilized by applications 214 through a set of exposed application programming interfaces and methods. The objects in object store 216 are maintained by applications 214 and operating system 212, at least partially in response to calls to the exposed application programming interfaces and methods.

Communication interface 208 represents numerous devices and technologies that allow mobile device 200 to send and receive information. The devices include wired and wireless modems, satellite receivers and broadcast tuners to name a few. Mobile device 200 can also be directly connected to a computer to exchange data therewith. In such cases, communication interface 208 can be an infrared transceiver or a serial or parallel communication connection, all of which are capable of transmitting streaming information.

Input/output components 206 include a variety of input devices such as a touch-sensitive screen, buttons, rollers, and a microphone as well as a variety of output devices including an audio generator, a vibrating device, and a display. The devices listed above are by way of example and need not all be present on mobile device 200. In addition, other input/output devices may be attached to or found with mobile device 200 within the scope of the present invention.

Under one aspect of the present invention, a system and method are provided that estimate noise in pattern recognition signals. To do this, the present invention uses a recursive algorithm to estimate the noise at each frame of a noisy signal based in part on a noise estimate found for at least one neighboring frame. Under the present invention, the noise estimate for a single frame is iteratively determined with the noise estimate determined in the last iteration being used in the calculation of the noise estimate for the next iteration. Through this iterative process, the noise estimate improves with each iteration resulting in a better noise estimate for each frame.

In one embodiment, the noise estimate is calculated using a recursive formula that is based on a non-linear relationship between noise, a clean signal and a noisy signal of:

y≈x+C ln (I+exp[C^{T}(n−x)]) EQ. 1

where y is a vector in the cepstra domain representing a frame of a noisy signal, x is a vector representing a frame of a clean signal in the same cepstral domain, n is a vector representing noise in a frame of a noisy signal also in the same cepstral domain, C is a discrete cosine transform matrix, and I is the identity matrix.

To simplify the notation, a vector function is defined as:

g(z)=C ln (I+exp[C^{T}z]) EQ. 2

To improve tractability when using Equation 1, the non-linear portion of Equation 1 is approximated using a Taylor series expansion truncated up to the linear terms, with an expansion point μ₀^{x}-n₀. This results in:

$$y = x + g ( {n}_{0} - {μ}_{0}^{x} ) + G ( {n}_{0} - {μ}_{0}^{x} ) ( x - {μ}_{0}^{x} ) + [ I - G ( {n}_{0} - {μ}_{0}^{x} ) ] ( n - {n}_{0} ) \qquad EQ . 3$$

where G is the gradient of g(z) and is computed as:

$$G ( z ) = C diag ( \frac{1}{1 + exp [ {C}^{T} z ]} ) {C}^{T} \qquad EQ . 4$$

The recursive formula used to select the noise estimate for a frame of a noisy signal is then determined as the solution to a recursive-Expectation-Maximization optimization problem. This results in a recursive noise estimation equation of:

nₜ₊₁=nₜ+Kₜ₊₁⁻¹sₜ₊₁ EQ. 5

where nₜ, is a noise estimate of a past frame, nₜ₊₁ is a noise estimate of a current frame and sₜ₊₁ and Kₜ₊₁ are defined as:

$${s}_{t + 1} = {\sum }_{m = 1}^{M} {{γ}_{t + 1} ( m ) [ I - G ( {n}_{0} - {μ}_{0}^{x} ) ]}^{T} {( {\sum }_{m}^{y} )}^{- 1} [ {y}_{t + 1} - {μ}_{m}^{y} ( {n}_{t + 1} ) ] \qquad EQ . 6$$

Kₜ₊₁=ε·Kₜ−Lₜ₊₁ EQ. 7

where

$${L}_{t + 1} = {\sum }_{m = 1}^{M} {{γ}_{t + 1} ( m ) [ I - G ( {n}_{0} - {μ}_{0}^{x} ) ]}^{T} {( {\sum }_{m}^{y} )}^{- 1} [ I - G ( {n}_{0} - {μ}_{0}^{x} ) ] \qquad EQ . 8$$

γₜ₊₁(m)=p(m|yₜ₊₁,nₜ) EQ. 9

and where ε is a forgetting factor that controls the degree to which the noise estimate of the current frame is based on a past frame, μₘ^{y} is the mean of a distribution of noisy feature vectors, y, for a mixture component m and Σₘ^{y} is a covariance matrix for the noisy feature vectors y of mixture component m. Using the relationship of Equation 3, μₘ^{y} and Σₘ^{y} can be shown to relate to other variables according to:

$${μ}_{m}^{y} = {μ}_{m}^{x} + g ( {n}_{0} - {μ}_{0}^{x} ) + G ( {n}_{0} - {μ}_{0}^{x} ) ( {μ}_{m}^{x} - {μ}_{0}^{x} ) + [ I - G ( {n}_{0} - {μ}_{0}^{x} ) ] ( n - {n}_{0} ) \qquad EQ . 10$$

Σₘ^{y}=[I+G(n₀−μ₀^{x})]Σₘ^{x}[I+G^{T}(n₀−μ₀^{x})]^{T} EQ. 11

where μₘ^{x} is the mean of a Gaussian distribution of clean feature vectors x for mixture component m and Σₘ^{x} is a covariance matrix for the distribution of clean feature vectors x of mixture component m. Under one embodiment, μₘ^{x} and Σₘ^{x} for each mixture component m are determined from a set of clean input training feature vectors that are grouped into mixture components using one of any number of known techniques such as a maximum likelihood training technique.

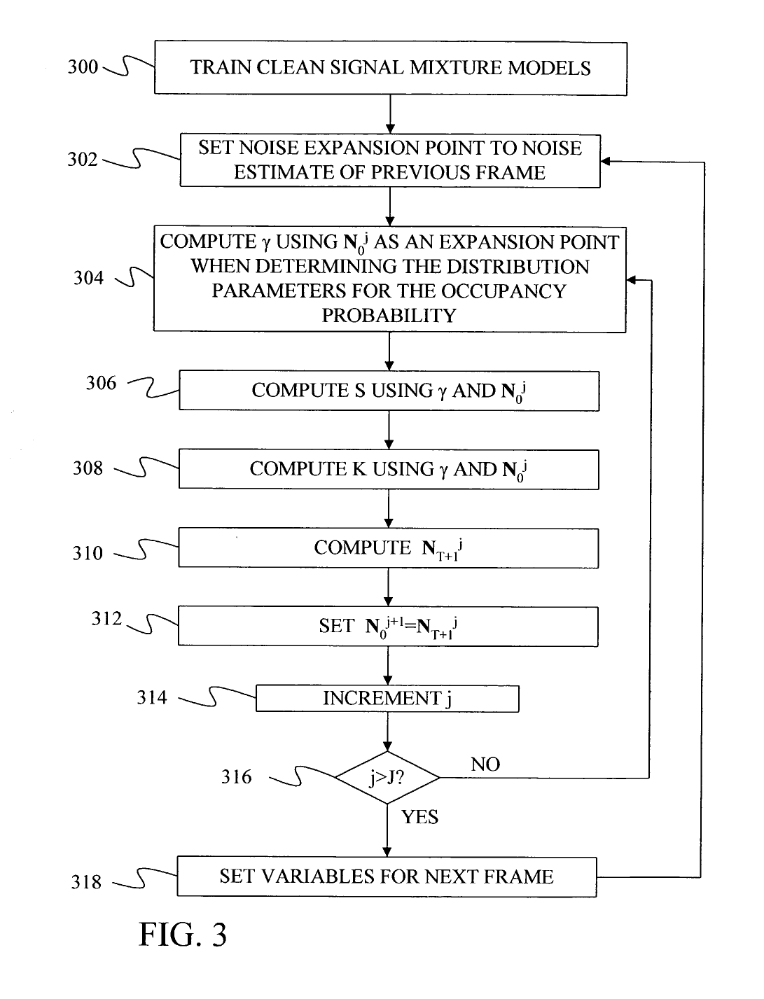

Under the present invention, the noise estimate of the current frame, nₜ₊₁, is calculated several times using an iterative method shown in the flow diagram of FIG. 3.

The method of FIG. 3 begins at step 300 where the distribution parameters for the clean signal mixture model are determined from a set of clean training data. In particular, the mean, μₘ^{x}, covariance, Σₘ^{x}, and mixture weight, cₘ, for each mixture component m in a set of M mixture components is determined.

At step 302, the expansion point, n₀^{j}, used in the Taylor series approximation for the current iteration, j, is set equal to the noise estimate found for the previous frame. In terms of an equation:

n₀^{j}=nₜ EQ. 12

Equation 12 is based on the assumption that the noise does not change much between frames. Thus, a good beginning estimate for the noise of the current frame is the noise found in the previous frame.

At step 304, the expansion point for the current iteration is used to calculate γₜ₊₁^{j}. In particular, γₜ₊₁^{j}(m) is calculated as:

$${γ}_{t + 1}^{j} ( m ) = \frac{p ( {y}_{t + 1} \vert m , {n}_{t} ) {c}_{m}}{{\sum }_{m = 1}^{M} p ( {y}_{t + 1} \vert m , {n}_{t} ) {c}_{m}} \qquad EQ . 13$$

where p(yₜ₊₁|m,nₜ) is determined as:

p(yₜ₊₁|m,nₜ)=N[yₜ₊₁;μₘ^{y}(n),Σₘ^{y}] EQ. 14

with

$${μ}_{m}^{y} = {μ}_{m}^{x} + g ( {n}_{0}^{j} - {μ}_{0}^{x} ) + G ( {n}_{0}^{j} - {μ}_{0}^{x} ) ( {μ}_{m}^{x} - {μ}_{0}^{x} ) + [ I - G ( {n}_{0}^{j} - {μ}_{0}^{x} ) ] ( {n}_{t} - {n}_{0} ) \qquad EQ . 15$$

Σₘ^{y}=[I+G(n₀^{j}−μ₀^{x})]Σₘ^{x}[I+G^{T}(n₀^{j}−μ₀^{x})]^{T} EQ. 16

After γₜ₊₁^{j}(m) has been calculated, sₜ₊₁^{j} is calculated at step 306 using:

$${s}_{t + 1} = {\sum }_{m = 1}^{M} {{γ}_{t + 1} ( m ) [ I - G ( {n}_{0}^{j} - {μ}_{m}^{x} ) ]}^{T} {( {\sum }_{m}^{y} )}^{- 1} [ {y}_{t + 1} - {μ}_{m}^{x} - g ( {n}_{0}^{j} - {μ}_{m}^{x} ) ] \qquad EQ . 17$$

and Kₜ₊₁^{j} is calculated at step 308 using:

$${K}_{t + 1}^{j} = ϵ {K}_{t}^{j} - {\sum }_{m = 1}^{M} {{γ}_{t + 1} ( m ) [ I - G ( {n}_{0}^{j} - {μ}_{0}^{x} ) ]}^{T} {( {\sum }_{m}^{y} )}^{- 1} [ I - G ( {n}_{0}^{j} - {μ}_{0}^{x} ) ] \qquad EQ . 18$$

Once sₜ₊₁^{j} and Kₜ₊₁^{j} have been determined, the noise estimate for the current frame and iteration is determined at step 310 as:

nₜ₊₁^{j}=nₜ+α·[Kₜ₊₁^{j}]⁻¹sₜ₊₁^{j} EQ. 19

where α is an adjustable parameter that controls the update rate for the noise estimate. In one embodiment α is set to be inversely proportional to a crude estimate of the noise variance for each separate test utterance.

At step 312, the Taylor series expansion point for the next iteration, n₀^{j+1}, is set equal to the noise estimate found for the current iteration, nₜ₊₁^{j}. In terms of an equation:

n₀^{j+1}=nₜ₊₁^{j} EQ. 20

The updating step shown in equation 20 improves the estimate provided by the Taylor series expansion and thus improves the calculation of γₜ₊₁^{j}(m), sₜ₊₁^{j} and Kₜ₊₁^{j} during the next iteration.

At step 314, the iteration counter j is incremented before being compared to a set number of iterations J at step 316. If the iteration counter is less than the set number of iterations, more iterations are to be performed and the process returns to step 304 to repeat steps 304, 306, 308, 310, 312, 314, and 316 using the newly updated expansion point.

After J iterations have been performed at step 316, the final value for the noise estimate of the current frame has been determined and at step 318, the variables for the next frame are set. Specifically, the iteration counter j is set to zero, the frame value t is incremented by one, and the expansion point n₀ for the first iteration of the next frame is set to equal to the noise estimate of the current frame.

The foregoing noise estimation technique provides a recursive-Expectation-Maximization optimization using a maximum likelihood criteria. In a further embodiment, noise estimation can be based on a MAP (maximum a posterior) criteria. In the embodiment illustrated, this algorithm is based on the maximum likelihood (ML) criteria as discussed above within the recursive-Expectation-Maximization framework.

The recursive-Expectation-Maximization framework includes an Expectation step and a Maximization step. In the Expectation step, the objective function with MAP criteria, or the MAP auxiliary function is given by

Q_{MAP}(nₜ)=Q_{ML}(nₜ)+p log p(nₜ), EQ. 21

where Q_{ML} (nₜ) is the maximum likelihood auxiliary function described above, and where p(nₜ) is the fixed prior distribution of Gaussian for noise nₜ, and where ρ is a variance scaling factor.

In equation 21, the quantity ρlogp(nₜ) can be referred to as “prior information”. From the terms contained therein, the prior information does not contain any data, i.e., observations yₜ, but rather, as based only on noise. In contrast, the auxiliary function Q_{ML} (nₜ) is based both on observations yₜ and noise nₜ. The prior information constrains Q_{ML} (nₜ) by providing, in effect, a range in which the noise should fall within. The variance scaling factor ρ weights the prior information relative to the ML auxiliary function Q_{ML} (nₜ).

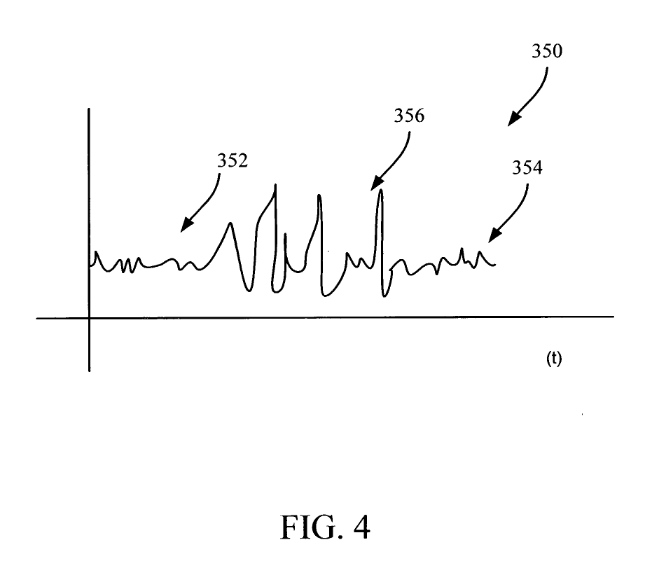

The prior information, and in particular, p(nₜ) is obtained from non-speech portions of an utterance. Referring to FIG. 4, a given pattern signal 350, herein by example an utterance, may have a preceding portion 352 and a following portion 354 that have no speech contained therein, and therefore, comprise only noise. In FIG. 4, portion 356 represents speech data. The prior information can be based on one or both of the portions 352 and 354. The prior information is made Gaussian by taking the mean and the variance. For example, in one embodiment, the portions used to compute the prior information can be identified by a level detector, which identifies corresponding portions as speech data if a level or energy content is exceeded, while those portions that do not exceed the selected level or energy content can be identified and used to calculate the prior information. However, it should be noted that calculation of the prior information is not limited to those portions immediately adjacent the speech portion 356 for a given utterance 350.

Referring back to equation 20, the maximum likelihood (ML) auxiliary function Q_{ML} (nₜ) can be expressed as the following conditional expectation:

$$\begin{matrix}{Q}_{ML} ( {n}_{t} ) = E [ log p ( {y}_{1}^{t} , {M}_{1}^{t} \vert {n}_{t} ) \vert {y}_{1}^{t} , {n}_{1}^{t - 1} ] \\ = {\sum }_{τ = 1}^{l} {\sum }_{m = 1}^{M} {ξ}_{τ} ( m ) log p ( {y}_{τ} \vert m , {n}_{t} ) ,\end{matrix} \qquad EQ . 22$$

which, after introducing the forgetting factor ε, becomes

$$\begin{matrix}{Q}_{ML ( {n}_{t} )} \approx {\sum }_{τ = 1}^{t} {ε}^{t - τ} {\sum }_{m = 1}^{M} {ξ}_{τ} ( m ) log p ( {y}_{τ} \vert m , {n}_{t} ) \\ = - {\sum }_{τ = 1}^{t} {ε}^{t - τ} {\sum }_{m = 1}^{M} {ξ}_{τ} ( m ) \frac{{( {y}_{τ} - {μ}_{m}^{y} )}^{2}}{2 {Σ}_{m}^{y}} + Const .\end{matrix} \qquad EQ . 23$$

The forgetting factor ε controls the balance between the ability of the algorithm to track noise non-stationary and the reliability of the noise estimate, M₁^{t} is the sequence of the speech model's mixture components up to frame t, and ξₜ(m)=p(m|y_{T},n_{T-1}) is the posterior probability.

It should be noted that the exponential decay of the forgetting factor ε herein illustrated is but one distribution for forgetting (i.e. weighting) factors that can be used. The example provided herein should not be considered limiting, because as appreciated by those skilled in the art, other distributions for forgetting factors can be used.

The posterior probability is computer using Bayes rule

$${ξ}_{τ} ( m ) = \frac{{c}_{m} p ( {y}_{τ} \vert m , {n}_{τ - 1} )}{{Σ}_{m} {c}_{m} p ( {y}_{τ} \vert m , {n}_{τ - 1} )} , \qquad EQ . 24$$

where likelihood p(m|y_{T},n_{T-1}) is approximated by a Gaussian with the mean and variance of

μₘ^{y}≈μₘ^{x}+gm+[1−Gₘ](nₜ−n₀) Σₘ^{y}≈(1+Gₘ)²Σₘ^{x}+(1−Gₘ)²Σⁿ. EQ. 25

In the above equation, gₘ and Gₘ are computable quantities introduced to linearly approximate the relationship among noisy speech y, clean speech x, and noise n (all in the form of log spectra). Σₙ is the fixed variance (hyper-parameter) of the prior noise PDF p(nₜ), which is assumed to be Gaussian (with the fixed hyper-parameter mean of μₙ). Finally, n₀ is the Taylor series expansion point for the noise, which is iteratively updated by the MAP estimate in the Maximization-step described below.

In the Maximization step, an estimate is obtained for nₜ by setting

$$\frac{\partial {Q}_{MAP} ( {n}_{t} )}{\partial {n}_{t}} = 0. \qquad EQ . 26$$

Noting from equation 25 that μₘ^{y} is a linear function of nₜ, the following equation is obtained:

$${\sum }_{τ = 1}^{t} {ε}^{t - τ} {\sum }_{m = 1}^{M} {ξ}_{τ} ( m ) \frac{( {y}_{T} - {μ}_{m}^{y} )}{{Σ}_{m}^{y}} ( 1 - {G}_{m} ) - \frac{ρ ( {n}_{t} - {μ}_{n} )}{{Σ}^{n}} = 0. \qquad EQ . 27$$

Substituting equation 25 into equation 27 and solving for nₜ, the MAP estimate of noise is represented by:

$${\hat{n}}_{t} = \frac{{s}_{t} + {ρμ}_{n} / {Σ}^{n} + {K}_{t} {n}_{0}}{{K}_{t} + ρ / {Σ}^{n}} , \\ \begin{matrix}where & \\ & {s}_{t} = {\sum }_{τ = 1}^{t} {ε}^{t - τ} {\sum }_{m = 1}^{M} {ξ}_{τ} ( m ) ( {y}_{τ} - {μ}_{m}^{x} - {g}_{m} ) \frac{( 1 - {G}_{m} )}{{Σ}_{m}^{y}} , \\ and & \\ & {K}_{t} = {\sum }_{τ = 1}^{t} {ε}^{t - τ} {\sum }_{m = 1}^{M} {ξ}_{τ} ( m ) \frac{{( 1 - {G}_{m} )}^{2}}{{Σ}_{m}^{y}} .\end{matrix} \qquad EQ . 28$$

The ^{s}ₜ and Kₜ above can be efficiently computed by making use of the previous computation for ^{s}ₜ₋₁ and Kₜ₋₁ via recursion as discussed above for the recursive ML noise estimation. In one embodiment, an efficient recursive computation for Kₜ can be represented as:

$${K}_{t} = ε {K}_{t - 1} + {\sum }_{m = 1}^{M} {ξ}_{t} ( m ) \frac{{( 1 - {G}_{m} )}^{2}}{{Σ}_{m}^{y}} .$$

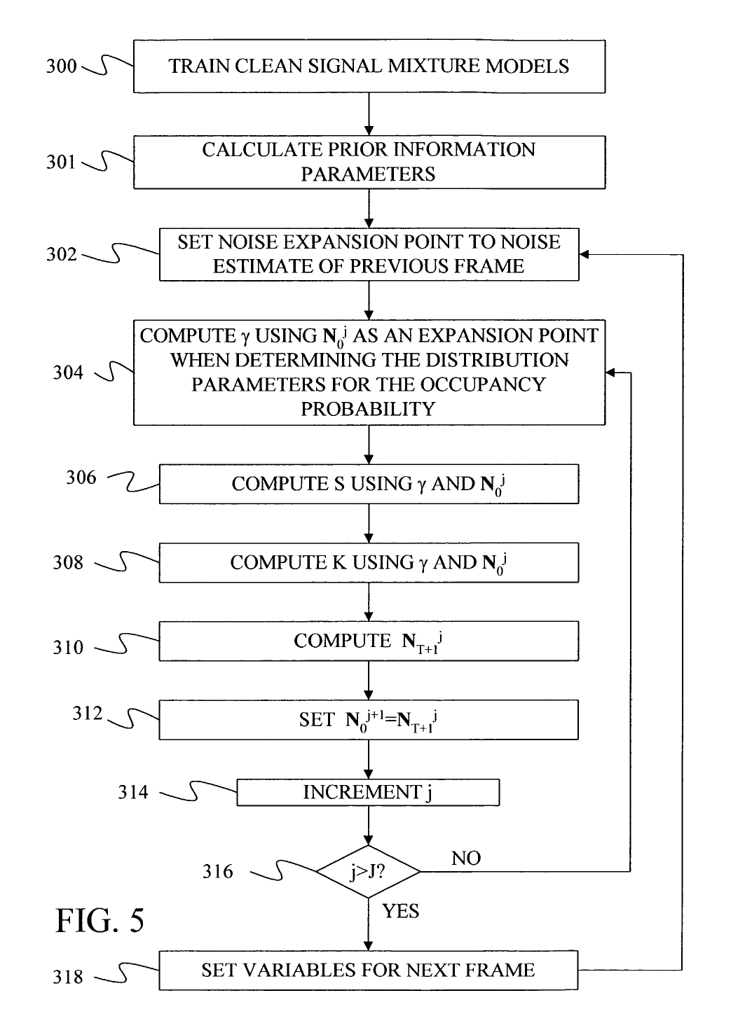

In general, the iterations illustrated in FIG. 3 are also followed in the MAP estimate of noise as illustrated in FIG. 5. However, an additional step 301 prior to step 302 includes calculation of the prior information for each utterance, wherein steps 302, 304, 306, 308, 310, 312, 314, 316 and 318 are performed for each utterance. (Note ξ is equivalent to γ.) Initially, n₀ can be set equal to the mean, μₙ, of the prior information.

It should be noted that the MAP estimate of Eq. 27 reverts to the ML noise estimate discussed above, when ρ is set to zero or when the variance of the noise prior distribution goes to infinity. In either of these extreme cases, the prior distribution of the noise would be expected to provide no information as far as noise estimation is concerned.

It should also be noted that the MAP estimate of noise nₜ is approximately equal to μₙ if the variance for the prior information is low. With respect to FIG. 4, this means that portions 352 and 354 are nearly identical, therefore, the noise estimate for the observation portion 356 should be substantially similar to the mean μₙ of the prior information. (In this situation, the terms ρμₙ/Σₙ and ρ/Σₙ dominate with ρ and Σₙ canceling out.)

The noise estimation techniques described above may be used in a noise normalization technique or noise removal such as discussed in a patent application entitled METHOD OF NOISE REDUCTION USING CORRECTION VECTORS BASED ON DYNAMIC ASPECTS OF SPEECH AND NOISE NORMALIZATION, application Ser. No. 10/117,142, filed Apr. 5, 2002. The invention may also be used more directly as part of a noise reduction system in which the estimated noise identified for each frame is removed from the noisy signal to produce a clean signal such as described in patent application entitled NON-LINEAR OBSERVATION MODEL FOR REMOVING NOISE FROM CORRUPTED SIGNALS, application Ser. No. ______, filed on even date herewith.

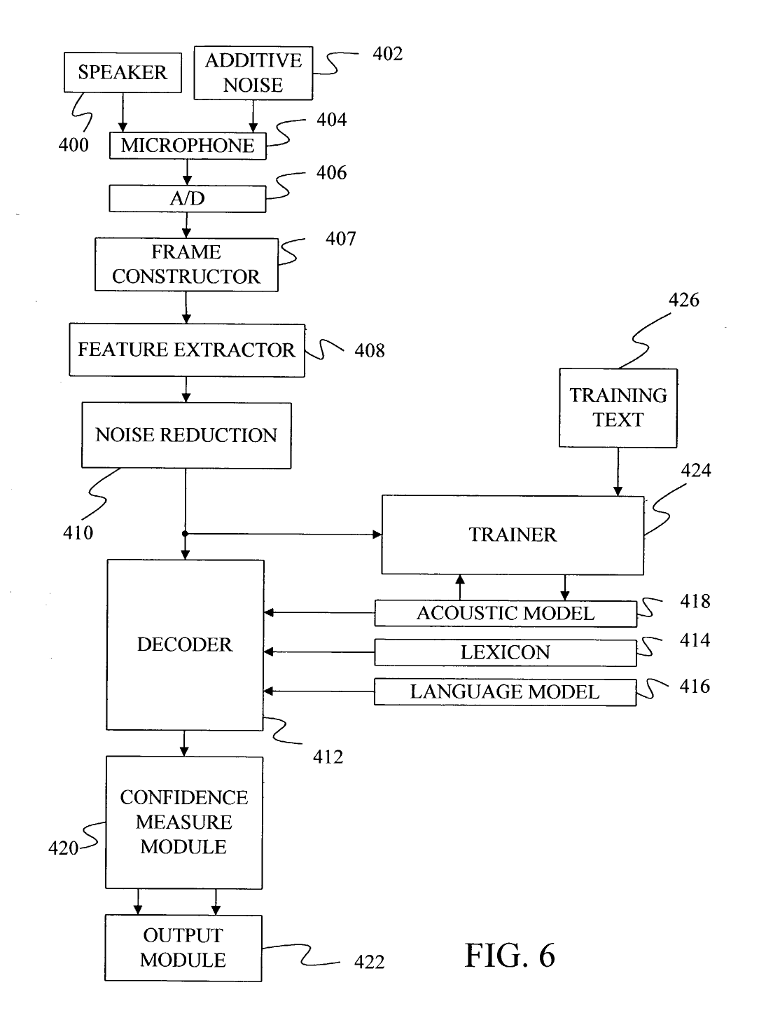

FIG. 6 provides a block diagram of an environment in which the noise estimation technique of the present invention may be utilized to perform noise reduction. In particular, FIG. 6 shows a speech recognition system in which the noise estimation technique of the present invention can be used to reduce noise in a training signal used to train an acoustic model and/or to reduce noise in a test signal that is applied against an acoustic model to identify the linguistic content of the test signal.

In FIG. 6, a speaker 400, either a trainer or a user, speaks into a microphone 404. Microphone 404 also receives additive noise from one or more noise sources 402. The audio signals detected by microphone 404 are converted into electrical signals that are provided to analog-to-digital converter 406.

Although additive noise 402 is shown entering through microphone 404 in the embodiment of FIG. 6, in other embodiments, additive noise 402 may be added to the input speech signal as a digital signal after A-to-D converter 406.

A-to-D converter 406 converts the analog signal from microphone 404 into a series of digital values. In several embodiments, A-to-D converter 406 samples the analog signal at 16 kHz and 16 bits per sample, thereby creating 32 kilobytes of speech data per second. These digital values are provided to a frame constructor 407, which, in one embodiment, groups the values into 25 millisecond frames that start 10 milliseconds apart.

The frames of data created by frame constructor 407 are provided to feature extractor 408, which extracts a feature from each frame. Examples of feature extraction modules include modules for performing Linear Predictive Coding (LPC), LPC derived cepstrum, Perceptive Linear Prediction (PLP), Auditory model feature extraction, and Mel-Frequency Cepstrum Coefficients (MFCC) feature extraction. Note that the invention is not limited to these feature extraction modules and that other modules may be used within the context of the present invention.

The feature extraction module produces a stream of feature vectors that are each associated with a frame of the speech signal. This stream of feature vectors is provided to noise reduction module 410, which uses the noise estimation technique of the present invention to estimate the noise in each frame.

The output of noise reduction module 410 is a series of “clean” feature vectors. If the input signal is a training signal, this series of “clean” feature vectors is provided to a trainer 424, which uses the “clean” feature vectors and a training text 426 to train an acoustic model 418. Techniques for training such models are known in the art and a description of them is not required for an understanding of the present invention.

If the input signal is a test signal, the “clean” feature vectors are provided to a decoder 412, which identifies a most likely sequence of words based on the stream of feature vectors, a lexicon 414, a language model 416, and the acoustic model 418. The particular method used for decoding is not important to the present invention and any of several known methods for decodeing may be used.

The most probable sequence of hypothesis words is provided to a confidence measure module 420. Confidence measure module 420 identifies which words are most likely to have been improperly identified by the speech recognizer, based in part on a secondary acoustic model (not shown). Confidence measure module 420 then provides the sequence of hypothesis words to an output module 422 along with identifiers indicating which words may have been impoperly identified. Those skilled in the art will recognize that confidence measure module 420 is not necessary for the practice of the present invention.

Although FIG. 6 depicts a speech recognition system, the present invention may be used in any pattern recognition system and is not limited to speech.

Although the present invention has been described with reference to particular embodiments, workers skilled in the art will recognize that changes may be made in form and detail without departing from the spirit and scope of the invention.

What is claimed is:

1. A method for estimating noise in a noisy signal, the method comprising:
dividing the noisy signal into frames;
determining a noise estimate for a first frame of the noisy signal;
determining a noise estimate for a second frame of the noisy signal based in part on the noise estimate for the first frame; and
using the noise estimate for the second frame and the noise estimate for the first frame to determine a second noise estimate for the second frame.

2. The method of claim 1 wherein using the noise estimate for the second frame and the noise estimate for the first frame comprises using the noise estimate for the second frame and the noise estimate for the first frame in an update equation that is the solution to a recursive Expectation-Maximization optimization problem.

3. The method of claim 2 wherein the update equation is based in part on a definition of the noisy signal as a non-linear function of a clean signal and a noise signal.

4. The method of claim 3 wherein the update equation is further based on an approximation to the non-linear function.

5. The method of claim 4 wherein the approximation equals the non-linear function at a point defined in part by the noise estimate for the second frame.

6. The method of claim 5 wherein the approximation is a Taylor series expansion.

7. The method of claim 1 wherein using the noise estimate for the second frame comprises using the noise estimate for the second frame as an expansion point for a Taylor series expansion of a non-linear function.

8. The method of claim 2 wherein each noise estimate is a function of a maximum likelihood criteria.

9. The method of claim 2 wherein each noise estimate is a function of a maximum a posterior criteria.

10. A computer-readable medium having computer-executable instructions for performing steps comprising:
dividing a noisy signal into frames; and
iteratively estimating the noise in each frame such that in at least one iteration for a current frame the estimated noise is based on a noise estimate for at least one other frame and a noise estimate for the current frame produced in a previous iteration.

11. The computer-readable medium of claim 10 wherein iteratively estimating the noise in a frame comprises using the noise estimate for the current frame produced in a previous iteration to evaluate at least one function.

12. The computer-readable medium of claim 11 wherein the at least one function is based on an assumption that a noisy signal has a non-linear relationship to a clean signal and a noise signal.

13. The computer-readable medium of claim 12 wherein the function is based on an approximation to the non-linear relationship between the noisy signal the clean signal and the noise signal.

14. The computer-readable medium of claim 13 wherein the approximation is a Taylor series approximation.

15. The computer-readable medium of claim 14 wherein the noise estimate for the current frame produced in a previous iteration is used to select an expansion point for the Taylor series expansion.

16. The computer-readable medium of claim 10 wherein iteratively estimating the noise in each frame comprises estimating the noise using an update equation that is based on a recursive Expectation-Maximization calculation.

17. The computer-readable medium of claim 16 wherein the recursive Expectation-Maximization calculation is a function of a maximum likelihood criteria.

18. The computer-readable medium of claim 16 wherein the recursive Expectation-Maximization calculation is a function of a maximum a posterior criteria.

19. The computer-readable medium of claim 18 wherein the maximum a posterior criteria includes prior information being a function only of noise.

20. The computer-readable medium of claim 19 and further comprising instructions for calculating a noise estimate of the prior information.

21. The computer readable medium of claim 20 wherein the noise estimate of the prior information is used initially in iteratively estimating the noise.

22. The computer readable medium of claim 10 and further comprising using the noise estimate to reduce noise in the noisy signal.

23. The computer readable medium of claim 10 and further comprising using the noise estimate to normalized noise.

24. A method of estimating noise in a current frame of a noisy signal, the method comprising:
applying a previous estimate of the noise in the current frame to at least one function to generate an update value; and
adding the update value to an estimate of noise in a second frame of the noisy signal to produce an estimate of the noise in the current frame.

25. The method of claim 24 wherein applying a previous estimate of the noise in the current frame comprise applying the previous estimate to a function that is based on an approximation to a non-linear function.

26. The method of claim 25 wherein the approximation is a Taylor series approximation.

27. The method of claim 26 wherein applying the previous estimate of the noise comprises using the previous estimate of the noise to define an expansion point for the Taylor series approximation.

28. The method of claim 25 wherein applying a previous estimate of the noise in the current frame to at least one function comprises applying the previous estimate to define distribution values for a distribution of noisy feature vectors in terms of distribution values for clean feature vectors.

29. The method of claim 28 wherein each noise estimate is a function of a maximum likelihood criteria.

30. The method of claim 28 wherein each noise estimate is a function of a maximum a posterior criteria.
